(19) United States
(12) Patent Application Publication
(10) Pub. No.: US 2003/0092777 A1
(43) Pub. Date: May 15, 2003

(54) Multi-component, on site foaming system and its use

(76) Inventor: Michael Leitner, Landsberg (DE)

Correspondence Address: DAVID TOREN, ESQ., SIDLEY, AUSTIN, BROWN & WOOD, LLP, 787 SEVENTH AVENUE, NEW YORK, NY, 10019-6018, US

(21) Appl. No.: 10/270,941

(22) Filed: Oct. 15, 2002

(30) Foreign Application Priority Data
Oct. 15, 2001 (DE) 101 50737.2

(51) Int. Cl. C09K 3/00

(52) U.S. Cl. 516/10

(57) ABSTRACT

A multi-component, on-site foaming system for producing polyurethane foams on site for building purposes, with a polyisocyanate component (A) and a polyol component (B), which are in separate containers, wherein, aside from the polyisocyanate component (A) and the polyol component (B), further components (C) and (D) are contained in a spatially separate form, the components, upon being mixed, forming an interpenetrating polymeric network of foamed polyurethane and at least one further polymer, use of the system for sealing openings and/or bushings in walls and/or ceilings of buildings, and a method for sealing openings or bushings, which consists therein that the multi-component, on-site foaming system is brought into the opening and/or the bushing with the help of a delivery device with mixing head, in which the components are mixed intimately, foamed and allowed to cure.

### BACKGROUND OF THE INVENTION

1. Field of Invention

The present invention relates to a multi-component, on site foaming system for producing polyurethane foams on site for building purposes, with a polyisocyanate component (A) and a polyol component (B), which are present in separate containers, the use of this on-site foaming system for sealing openings and/or wall and/or ceiling bushings of buildings and a method for sealing such openings and/or bushings.

2. Description of the Prior Art

Every building has openings and/or bushings in the walls and/or ceilings, through which pipes, cables, etc. are passed. Such openings or bushings must be sealed in a mechanically stable manner especially against water or against fire.

Normally, the annular gap of the bushing for a pipe or cable in the wall or ceiling of a building is sealed mechanically, chemically, or chemically and mechanically. For the mechanical sealing, the annular gap is filled with the help of solid sealing elements. These mechanical elements seal due to an accurate closing shape or by elastic compaction with the substrate. Such mechanical sealing devices are expensive, time consuming and work intensive and, because the sealing elements must fit accurately, are limited to pipes, cables and boreholes of a particular diameter.

For the chemical sealing, the opening is filled with a reactive system, which is cured and seals the bushing. For this purpose, inorganic systems, such as mortar or organic systems, such as sealing compositions, polymer foam, etc. can be used. It is furthermore possible to combine such a chemical sealing with a mechanical sealing by having a mechanical sheathing, which takes up the chemical sealing material.

Chemically sealing, by filling the opening with sealing compositions, foams or mortars, does not have the disadvantages of the mechanical systems. However, it frequently does not ensure permanent sealing against the entry of water or against fire. When a foam system is used, especially in the area of fire protection seals, it is necessary to add functional additives such as expanded graphite or ammonium polyphosphate, to the starting materials, in order to achieve a foam with the desired properties. However, because of the mixing technique that is required (blending technique) for combining the starting materials, such foams have a relatively poor mechanical load-carrying capacity, since the additives added are not bound covalently to the foam matrix and, instead, are present as separate domains in the polymer matrix. Therefore, with respect to their specific function, these foam systems also lose their effectiveness relatively quickly, because the system of foam matrix and additives changes significantly over time due to aggregation, diffusion or oxidation of the additive.

Interpenetrating polymer networks and their production are known, for example, from Rümpp, Lexikon Chemie (Chemical Encyclopedia), 10^{th} edition, 1997, page 1945. Such networks can be produced in different ways, for example, by simultaneously polymerizing two or more different monomers in the presence of cross-linking agents. In this case, the polymerization reaction must be specific for each of the monomers used, in that, for example, and with the help of the first cross-linking agent, the first monomer forms a polymeric network, in which the second monomer can hardly, if at all, be incorporated covalently. With the help of the second cross-linking agent, the second monomer then forms a second network, into which the first monomer can hardly, if at all, be bonded. Depending upon the number of different monomers and of the different types of polymerization, several networks can be interlaced with one another.

The essential property of such interpenetrating, polymeric networks is seen to lie therein that the polymer networks formed have mutually penetrated one another, there being only a few, if any chemical bonds between the different networks. Because of the mutual penetration and their cross-linking, the interpenetrating polymeric systems can no longer demix, so that the mechanical stability of such systems is particularly high.

The EP-A-0 230 666 discloses a curable, one-component adhesive composition based on an interpenetrating network of urethane, epoxy and silicone polymers.

The EP-B-0 753 020 discloses a water-dispersible, interpenetrating, polymeric network based on a water-dispersible thermoplastic polymers, which are based on a fully reacted, isocyanate-containing urethane and/or urea compounds and an interpenetrating addition polymer based on an ethylenically unsaturated monomer.

U.S. Pat. No. 4,923,934 describes interpenetrating polymer networks based on a blocked urethane prepolymer, a polyol, an epoxide resin and an anhydride as catalyst for the epoxide resin. The interpenetrating polymers are used as coating compositions.

U.S. Pat. No. 4,212,953 discloses a fire-resistant polyurethane foam composition in the form of an interpenetrating network of a urethane polymer and a phosphorus-containing polymer, which provides the necessary fire-protection properties because of the lateral phosphorus groups.

It is an object of the present invention to solve the above-mentioned problems of sealing openings and/or bushings in walls and/or ceilings of buildings and to provide a water-sealing and/or fire-sealing foam system, which not only is less expensive than conventional mechanical solutions, but also can be employed on site, that is, for example, on building sites, quickly and simply and retain its properties also for a long time before and after its use.

### SUMMARY OF THE INVENTION

Surprisingly it has turned out that this objective can be accomplished with the help of a multi-component on site foaming system for the production of polyurethane foams, which can be foamed on site, and is formed from an interpenetrating network of foamed polyurethane and at least one other polymer. The desired properties of the foam can be affected selectively by the additional polymer or polymers and, moreover, in such a manner that the additional polymer, which brings about these properties, is part of the interpenetrating network, from which it cannot be exuded or dissolved and in which it cannot aggregate.

This object is achieved by the multi-component, on-site foaming system which, when mixed, forms an interpenetrating polymer network of foamed polyurethane and at least one additional polymer.

The object of the invention therefore is a multi-component, on-site foaming system for producing polyurethane foams for building purposes on site, with a polyisocyanate component (A) and a polyol component (B), which are in separate containers, and is characterized in that it contains, in addition to the polyisocyanate component (A) and the polyol component (B), further components (C) and (D), which are contained in a specially separated form and, upon mixing, form an interpenetrating network of foamed polyurethane and at least one further polymer.

In accordance with a preferred embodiment of the invention, the components (C) and (D) are contained in such a manner in the containers for the polyisocyanate component (A) and the polyol component (B), that their reaction with the formation of the foamed interpenetrating network takes place only after the contents of the containers are mixed. It must therefore be ensured that the components in their respective containers do not react prematurely with one another and that the reaction starts by itself only when the components (A) and (B), with the constituents contained therein, are mixed. In this connection, it may be necessary that one of the components (C) or (D), which can react with one or the other constituent of the components (A) or (B), is in one or more additional, separate containers.

In this way, it is ensured that the inventive multi-component, on-site foaming system has the necessary shelf life before it is used as intended.

For the inventive, on-site foaming system, the different components (A) to (D) provide the desired properties to the interpenetrating polymeric network, which is in the form of a foam and is formed by mixing these components and reacting them with foaming and curing. The polyisocyanate components (A) and the polyol components (B) form a solid polyurethane foam, the properties of which can be changed in the desired manner by the presence of components (C) or (D). Admittedly, the use of polyurethane foams in on-site foaming systems for building purposes has long been known. The reaction between polyisocyanate and water is used here, carbon dioxide being formed, which foams the polyurethane formed. However, the polyurethane foams resulting here, considered by themselves, do not have good water-sealing properties or satisfactory fire-protection properties. Since the mixing in of additives does not lead to an improvement in these properties, as stated above, the present invention teaches the combination of the polyurethane network with a further polymeric network, which is formed from components in (C) and (D) and serves to provide the polyurethane foam with the desired mechanical, water-tightness and fire-protection properties. Accordingly, pursuant to the invention, the water resistance of the polyurethane foam as well as its fire resistance can be improved in the desired manner by the appropriate selection of component (C) and (D) in that the claimed multi-component, on-site foaming system is formed into an interpenetrating polymeric network, which has very good adhesion to the surrounding wall material and, with that, prevents penetration by water, or which in the event of a fire, in spite of the high surrounding temperatures and the oxidative atmosphere, forms a mechanically stable fire crust, which offers the necessary resistance to the fire.

Due to the introduction of this “additive”, which improves the properties of the polyurethane foam in a selective manner in the form of an interpenetrating network, a cured polyurethane foam is obtained with outstanding mechanical, physical and chemical properties. Furthermore, demixing of the interpenetrating components of the foam system cannot take place. With that, the properties of the foam system are maintained even during prolonged periods.

### DETAILED DESCRIPTION OF THE PREFERRED EMBODIMENTS

Preferably, the inventive on-site foaming system contains, as polyisocyanate component (A), at least one polyisocyanate with an NCO content of 5 to 55% and preferably of 20 to 50%, and an average number of 2 to 5 and preferably 2 to 4 NCO groups per molecule. Especially preferred is a polyisocyanate, which is based on methylene diphenyl diisocyanate and/or polymeric homologues thereof, particularly one with an NCO content of 31% and, on the average, 2.7 NCO groups per molecule

The polyol component (B) comprises at least one polyol with an OH number of 30 to 1000 and preferably 500 to 1000, an average OH functionality per molecule of 2 to 7 and preferably of 2 to 4. Particularly preferred are polyether polyols and/or polyester polyols with an OH number of 300 to 1000 and preferably of 500 to 1000 and the OH functionalities given above, as well as aminopolyether polyols and/or polyols based on esters of phosphoric acid with an OH number of 30 to 1000, and preferably of 100 to 300 and an average OH functionality per molecule of 2 to 7 and preferably of 3 to 5. Furthermore, halogenated polyols with an OH number of 30 to 1000 and preferably of 100 to 300 and an average OH functionality per molecule of 1.5 to and preferably of 2 to 4, are particularly preferred.

Preferably, an epoxide resin and/or a siloxane prepolymer are contained in the inventive on-site foaming system as components (C). The epoxide resin serves preferably to improve the water tightness of the polyurethane foam, while the siloxane prepolymer, when cross linked appropriately, provides the interpenetrating polymeric network with increased fire resistance.

The epoxide resin preferably is one with an epoxy equivalent weight of 100 to 500 g/mole and preferably of 150 to 200 g/mole, epoxide resins based on bisphenol A and bisphenol F, especially of 70% bisphenol A and 30% bisphenol F being preferred. The epoxide resin may also be halogenated and, in particular, brominated.

The epoxide resin, as component C, is preferably contained in an amount of 10 to 50% by weight and preferably of 15 to 35% by weight, based on the total weight of the on-site foaming system.

Preferably, as siloxane prepolymer, component (C) comprises a siloxane prepolymer with an average molecular weight to 200 g/mole up to 10,000 g/mole and preferably of 400 g/mole to 3,000 g/mole, and 2 to 4 and preferably 2 to 3 reactive end groups, especially low molecular weight alkoxy end groups and low molecular weight alkyl ester end groups, preferably methoxy end groups.

Preferably, the characteristic number of the polyurethane reaction ranges from 95 to 165 and, particularly, from 102 to 120.

The characteristic number of the polyurethane reaction is understood to be the amount of the isocyanate groups used (amount of effectively used isocyanate groups, namely n_{NCO}) as a percentage of the active hydrogen functions (amount of effectively used active hydrogen functions, namely n_{activeH}), which are supplied, for example, by the OH groups of polyols, by NH₂ groups of amines or by COOH groups of carboxylic acids. An equivalent amount of isocyanate corresponds to the characteristic number of 100 and a 10% excess of isocyanate groups corresponds to the characteristic number of 110. The formula, required for the calculation of the characteristic number, is as follows:

characteristic number=(n_{NCO}/n_{H})×100

As further components, the polyol component (B) contains water, by means of which the polyurethane is foamed, in an amount, which results in a polyurethane foam with a foam density of 0.05 to 0.5 g/cc and preferably of 0.2 to 0.4 g/cc, one or more catalysts for the reaction forming the polyurethane, the component (D) for forming the further polymer or polymers and optionally a foam cell stabilizer.

As catalyst for the polyurethane-forming reaction, the polyol component (B) preferably may contain one or more tertiary amines, especially dimorpholine diethyl ether.

The polyol component (B) of the inventive multi-component, on-site foaming system preferably contains, as component (D) for the formation of the other polymer based on an epoxide resin, a conventional catalyst for the polymerization of the epoxide resin, especially a Lewis acid, preferably a phenol and particularly 2,4,6-(trisdimethylaminomethyl)-phenol.

In accordance with a further embodiment, the polyol component (B) contains, as component (D) for the formation of the additional polymer on the basis of a siloxane pre-polymer, a conventional cross-linking agent for the siloxane pre-polymer, preferably an organooxysilane with at least three low molecular weight alkoxy end groups, preferably methoxy end groups, per molecule and, for example, an average molecular weight ranging from 100 to 1,000 g/mole.

As foam cell stabilizer, a known material for stabilizing cell formation, especially a polysiloxane, for example, may be present in the polyol component (B) during the foaming reaction.

The inventive, multi-component, on-site foaming system may optionally contain known and conventional fillers, auxiliary materials and/or additives in conventional amounts, these conventional additives being contained in components (A), (B), (C) and/or (D). As such additives, preferably 0 to 40% by weight and especially 1 to 20% by weight of fillers, such as sand, chalk, perlite, carbon black or mixtures thereof, 0 to 2% by weight and preferably 0.1 to 1% by weight of one or more dyes or pigments and/or 0 to 40% by weight and preferably 1 to 20% by weight of fire-inhibiting additives, such as halogen-containing fire-prevention agents, such as tris(2-chloroisopropyl)-phosphate, ablative fire-inhibiting additives, such as, for example, aluminum hydroxide, crust-forming fire-inhibiting additives, such as, for example, ammonium polyphosphate, and materials, which expand as the temperature increases, such as, for example, expanded graphite, amounts of these additives in each case being related to the total weight of the on-site foaming system, are preferred.

Pursuant to a further, preferred embodiment, the inventive multi-component, on-site foaming system is contained in containers, which are connected with a mixing head, in which the components are mixed, over feed lines with a delivery device. For example, the delivery device has a mixing head in the form of a mouthpiece with a static mixer.

These containers may furthermore be provided with extrusion devices, by means of which components (A) to (D) can be bought into the mixing head of the delivery device. These extrusion devices may be mechanical pressing devices and/or propellants, which are contained in components (A) to (D) and/or in the pressure chamber of a two-chamber cartridge. Such propellants preferably are inert, compressed or liquefied gases such as nitrogen or fluorinated hydrocarbons, such as 1,1,1,2-tetrafluoroethane (propellant 134a) or 1,1,1,2,3,3,3-heptafluoropropane. (propellant 227), as well as hydrocarbons, such as butane, propane or mixtures thereof.

A further object of the invention is the use of the multi-component, on-site foaming system of the above-described type for sealing openings and/or bushings in walls and/or ceilings of buildings and a method for sealing such openings and bushings, which consists therein that the inventive multi-component, on-site foaming system is mixed with the help of the delivery device with mixing head, in which the components are mixed, introduced into the opening and/or bushing and foamed and allowed to cure.

Surprisingly, it has turned out that, in contrast to the interpenetrating, polymeric networks known from the state of the art, the multi-component, on-site foaming system, built up in the inventive manner, does not foam and cannot be cured into polyurethane foams with the desired properties only under the usual, industrial conditions with a high process control and under conditions optimized for the formation of the foam, but also under the difficult conditions of a building site, such as, different temperatures ranging from 0° to 40° C., the very inhomogeneous volumes, which must be filled, and the different materials surrounding the foam, namely concrete, stone, steel and pipes of plastic, such as polyethylene and polyvinyl chloride, or also of copper.

Moreover, the inventive, multi-component, on-site foaming system can be applied and used in a very simple and rapid manner by means of a cartridge technique employing a mechanical extrusion device or with the help of a spray gun using containers in the form of two-chamber packages with a pressure chamber.

The following examples are intended to explain the invention further.

### EXAMPLE 1

Multi-component, on-site foaming system for producing a water-tight, interpenetrating, polymeric network of polyurethane foam and epoxide resin.

The components, given in the following Table 1, were used to prepare the inventive multi-component, on-site foaming system:

TABLE 1

| Component | Description | Characteristic Value | Weight | |
|---|---|---|---|---|
| Polyisocyanate | Based on methylene | NCO content: 31%, | 63 | g |
| | diphenyl diisocyanate | average number of | | |
| | (MDI) and polymeric | NCO groups per | | |
| | homologues of MDI | molecule: 2.7 | | |
| Polyol 1 | Polyether polyol based | OH No.: 860, average | 16 | g |
| | on trimethylolpropane | number of OH groups | | |
| | (TMP) | per molecule: 3 | | |
| Polyol 2 | Aminopolyether | OH No.: 480, average | 16 | g |
| | polyol | number of OH groups | | |
| | | per molecule: 4 | | |
| Epoxide resin | Based on 70% | Epoxy equivalent | 45 | g |
| | bisphenol A and 30% | weight: 175 g/mole | | |
| | bisphenol F | | | |
| Water | | OH No.: 6240 | 0.4 | g |
| Catalyst 1 | Dimorpholine diethyl | | 0.6 | g |
| | ether | | | |
| Catalyst 2 | 2,4,6-Tris(dimethyl- | | 0.5 | g |
| | aminomethyl)-phenol | | | |
| Foam cell | Polysiloxane | | 3 | g |
| stabilizer | | | | |

The formulation, given in the above Table 1,-relates to a total weight of 144.5 g. Because of the polyurethane stoichiometry, the characteristic number for the polyurethane portion of the foam is 110.

The component (A) is formed by mixing the epoxide resin with the polyisocyanate. The component (B) is produced by mixing polyols 1 and 2, the water, the catalysts 1 and 2 and the foam cell stabilizer.

The two components (A) and (B) are placed in separate containers in the form of two cartridges, which are connected over supply lines with a delivery device with mixing head, in which components (A) and (B) are mixed. For using the inventive on-site foaming system, the components of the two containers are expressed from the cartridges for the mouthpiece with the help of an extrusion device and brought into the opening that is to be filled.

After the two components are mixed, essentially three chemical reactions take place, namely the formation of the polyurethane, the polymerization of the epoxide resin and the foaming reaction.

The polyurethane network is formed by reacting the polyisocyanate with the polyol 1 and the polyol 2 in the presence of catalyst 1 and foamed by the reaction of the polyisocyanate with the water present with formation of carbon dioxide. The epoxide resin, which is cured in the presence of catalyst 2, supplies the properties necessary for the function of the polyurethane foam, namely a high hydrophobicity and a good adhesion to concrete and stone.

The density of this polyurethane foam, which is cured after about 5 minutes at 20° C., is 0.30 g/cc.

The polyurethane foam, obtained after the foaming and curing, has a surprisingly high water-tightness in comparison to a foam, which is produced in an analogous manner without an interpenetrating epoxide resin network. Under test conditions, which are described in the following, a water pressure of 6 bar is withstood for two hours without leakage, whereas the comparison foam leaked already after 20 minutes at a water pressure of 1 bar.

To check the water tightness, a hole with a diameter of 10 cm and a depth of 50 cm is drilled in the center of a concrete block with a height of 1 meter, a width of 50 cm and a thickness of 50 cm. By means of foam spacers, a polyethylene tube with a length of 1 meter and a diameter of 5 cm is centered in the drilled hole in such a manner, that the one side of the hole can be filled with a foam to a depth of 20 cm. The inventive on-site foaming system of the above composition is then introduced into the borehole and cured overnight. The foam material, protruding over the borehole, is then sawn of Subsequently, the concrete arrangement with the foamed material is clamped in a test apparatus, in which the foamed side of the concrete hole is in direct contact with water, which can be acted upon, over a compressed gas line, with a total gas pressure of not more than 6 bar. This side of the concrete, which is under water pressure, is sealed, the effective pressure being read continuously with the help of a manometer. On the other side of the concrete block, the penetration of water can be detected optically or with the help of a moisture sensor. The test is started with a pressure of 1 bar for two hours to see whether the foam leaks. If it does not, the pressure is increased by 1 bar for a further two hours. These measures are repeated until the foam leaks or until the limiting pressure of 6 bar is withstood successfully by the foam, without leakage, for two hours.

In order to demonstrate the interpenetrating character of the polymers of the foam obtained with the help of the inventive on-site foaming system, the glass transition temperature (T_{g}) of the interpenetrating foaming system obtained and that of the components, which were polymerized separately, were measured by means of differential scanning calorimetry (DSC). The glass transition temperature of a polymer is the temperature at which the polymer changes from a glassy state to the fluid state, that is, the temperature at which a significant decrease in viscosity of the polymer can be observed. In phase-separated polymer systems, which are constructed from two different polymers, two different glass transition temperature stages can be determined with the help of differential scanning calorimetry, if the glass transition temperatures of the two individual polymers are sufficiently far apart.

For example, a mixture of polystyrene and polybutadiene, which are present in separate phrases in one mixture, shows the glass transition temperature of polystyrene (100° C.) as well as that of polybutadiene (−70° C.).

However, if the two different polymers are present as an interpenetrating network, differential scanning elementary shows only a single glass transition temperature, which lies between the glass transition temperatures of the two polymers, which form the interpenetrating polymeric network.

The polyurethane/epoxide foam, formed from the above in-situ foaming system, shows a glass transition temperature of 120° C. during differential scanning calorimetry. A polymer, consisting exclusively of epoxide resin, has a glass transition temperature of 100° C., while the foam, consisting exclusively of polyurethane, has a glass transition temperature of 150° C. From this, it can be seen that, if the on-site, inventive foaming system is reacted and cured as specified, an interpenetrating polymeric network is formed from the two components, polyurethane and epoxide resin.

### EXAMPLE 2

Multi-component, on-site foaming system for producing a fire-proof foam from an interpenetrating polymeric network of polyurethane, epoxide resin and a cross-linked siloxane prepolymer

The components, given in the following Table 2, were used to produce this multi-component on-site foaming system:

| Component | Description | Characteristic Value | Weight | |
|---|---|---|---|---|
| Polyisocyanate | Based on methylene | NCO content: 31%, | 69 | g |
| | diphenyl diisocyanate | NCO groups per | | |
| | (MDI) and polymeric | molecule: 2.7 | | |
| | homologues of MDI | | | |
| Polyol 1 | Polyether polyol based | OH No.: 860, average | 20 | g |
| | on trimethylolpropane | number of OH groups | | |
| | (TMP) | per molecule: 3 | | |
| Polyol 2 | Polyester polyol based | OH No.: 185, average | 19 | g |
| | on terephthalic acid | number of OH groups | | |
| | | per molecule: 2 | | |
| Polyol 3 | Polyol, based on a | OH No.: 130, number | 18 | g |
| | phosphate ester | of OH groups per | | |
| | | molecule: 2 | | |
| Epoxide resin | Based on 70% | Epoxy equivalent | 28 | g |
| | bisphenol A and 30% | weight: 175 g/mole | | |
| | bisphenol F | | | |
| Siloxane pre- | Siloxane with to | Average molecular | 28 | g |
| polymer | methoxy end groups | weight of the order of | | |
| | | 2,000 g/mole | | |
| Cross-linking | Silane with three | Average molecular | 4 | g |
| agent | methoxy end groups | weight of the order of | | |
| | | 300 g/mole | | |
| Water | | OH No.: 6240 | 0.5 | g |
| Catalyst 1 | Dimorpholine diethyl | | 0.5 | g |
| | ether | | | |
| Catalyst 2 | 2,4,6-Tris(dimethyl- | | 1.0 | g |
| | aminomethyl)-phenol | | | |
| Foam cell | Polysiloxane | | 3 | g |
| stabilizer | | | | |

The above components relate to a total weight of 191 g. According to the polyurethane stoichiometry, the characteristic number for the polyurethane portion of the foam is calculated to be 110.

Of the above components, the polyisocyanate and the polyols 1, 2 and 3, together with the water and catalyst 1, form the polyurethane foam. The epoxide resin is cured with the help of catalyst 2 in the form of an interpenetrating network. The methoxy end groups of the siloxane pre-polymer and of the cross-linking agent must first be hydrolyzed with water to form silanol groups, before the actual cross-linking reaction, the condensation of the silanol groups, can take place. The third interpenetrating polymer is formed in this manner.

Of the above components, the polyisocyanate with the epoxide resin and the siloxane pre-polymer and the cross-linking agent are mixed to form component (A).

When the remaining components are mixed, component (B) is formed.

These components are brought into separate containers in a manner described in example 1 and, when used as specified, are supplied over the feed lines to a delivery device with mixing head, from where the mixture, which is to be foamed and cured, is introduced into the opening that is to be sealed.

The density of the polyurethane foam, cured after about five minutes at 20° C., is 0.24 g/cc.

The interpenetrating polyurethane foam, produced in this manner with a network of polyurethane, cured epoxide resin and cross-linked siloxane polymer, has a glass transition temperature of 80° C. Since the foam, which is built up exclusively from polyurethane, has a glass transition temperature of 110° C. and the epoxide resin polymer and the cross-linked siloxane polymer have glass transition temperatures of 70° C., it may be assumed that an interpenetrating polymeric network of three polymeric components is formed when the inventive, on-site foaming system is foamed and cured as specified.

Because of the presence of the cross-linked siloxane polymer, the foam shows excellent fire-resistance properties in the form of a relatively high residual ash content after the foam is tempered at a high temperature of 800° C. and a good mechanical stability of the ash crust, which is formed during the heating and tempering at this high temperature.

Though the present invention was shown and described with references to the preferred embodiments, such are merely illustrative of the present invention and are not to be construed as a limitation thereof and various modifications of the present invention will be apparent to those skilled in the art. It is therefore not intended that the present invention be limited to the disclosed embodiments or details thereof, an the present invention includes all variations and/or alternative embodiments with the spirit and scope of the present invention as defined by the appended claims.

What is claimed is:

1. A multi-component, on-site foaming system for producing polyurethane foams on site for building purposes, with a polyisocyanate component (A) and a polyol component (B), which are in separate containers, wherein, aside from the polyisocyanate component (A) and the polyol component (B), further components (C) and (D) are contained in a spatially separate form, with the components, upon being mixed, forming an interpenetrating polymeric network of foamed polyurethane and at least one further polymer.

2. The multi-component, on-site foaming system of claim 1, wherein the constituents of components (C) and (D) are contained in the containers for the polyisocyanate component (A) and the polyol component (B) in such a manner, that a reaction takes place only after the contents of the containers are mixed.

3. The multi-component, on-site foaming system of claim 1, wherein one of the components (C) or (D) is present in a further container.

4. The multi-component, on-site foaming system of claim 1, wherein the polyisocyanate component (A) comprises at least one polyisocyanate with an NCO content of 5 to 55 percent and preferably of 20 to 50 percent and an average number of 2 to 5 and preferably of 2 to 4 NCO groups per molecule.

5. The multi-component, on-site foaming system of claim 4, wherein the polyisocyanate component (A) comprises a polyisocyanate based on methylene diphenyl diisocyanate and/or polymeric homologues thereof.

6. The multi-component, on-site foaming system of claim 6, wherein the polyisocyanate component (A) comprises a polyisocyanate based on methylene diphenyl diisocyanate and/or polymeric homologues thereof with an NCO content of 31 percent and, on the average, 2.7 NCO groups per molecule.

7. The multi-component, on-site foaming system of claim 1, wherein the polyol component (B) comprises at least one polyol with an OH No. of 30 to 1,000 and preferably of 500 to 1,000 and an average OH functionality per molecule of 2 to 7 and preferably of 2 to 4.

8. The multi-component, on-site foaming system of claim 7, wherein the polyol component (B) comprises at least one polyether polyol and/or polyester polyol with an OH No. of 300 to 1,000 and preferably of 500 to 1,000 and an average OH functionality of 2 to 7 and preferably of 2 to 4 and/or at least one amino polyether polyol and/or a polyol based on phosphate esters with an OH No. of 30 to 1,000 and preferably of 100 to 300 and an average OH functionality for a molecule of 2 to 7 and preferably of 3 to 5.

9. The multi-component, on-site foaming system of claim 1, wherein the polyisocyanate component (A) contains an epoxide resin and/or a siloxane pre-polymer as component (C).

10. The multi-component, on-site foaming system of claim 9, wherein an epoxide resin with an epoxy equivalent weight of 100 to 500 g/mole and preferably of 150 to 200 g/mole is contained as component (C).

11. The multi-component, on-site foaming system of claim 10, wherein an epoxide resin, based on 70 percent bisphenol A and 30 percent and bisphenol F, is contained

12. The multi-component, on-site foaming system of claim 1, wherein the epoxide resin is contained as component (C) in an amount of 10 to 50 percent by weight and preferably of 15 to 35 percent by weight, based on the weight of the on-site foaming system.

13. The multi-component, on-site foaming system of claim 10, wherein a siloxane pre-polymer with an average molecular weight of 200 g/mole to 10,000 g/mole and preferably of 400 g/mole to 3,000 g/mole and 2 to 4 and preferably 2 to 3 reactive end groups, especially low molecular weight alkoxy and alkyl ester end groups, preferably methoxy end groups, is contained as component (C).

14. The multi-component, on-site foaming system of claim 1, wherein the characteristic number of the polyurethane reaction ranges from 95 to 165 and preferably from 102 to 120.

15. The multi-component, on-site foaming system of claim 1, wherein the polyol component (B) contains water in an amount, which results in a polyurethane foam with a foam density of 0.05 to 0.5 g/cc and preferably of 0.2 to 0.4 g/cc, one or more catalysts for the polyurethane-forming reaction, component (D) for forming the additional polymers and optionally a foam cell stabilizer.

16. The multi-component, on-site foaming system of claim 15, wherein the polyol component (B) contains one or more tertiary amines, preferably dimorpholine diethyl ether as catalyst for the polyurethane foam-forming reaction.

17. The multi-component, on-site foaming system of claim 15, wherein the polyol component (B) contains a conventional catalyst for the polymerization of the epoxide resin, preferably a Lewis acid, particularly a phenol, especially 2,4,6-tris (dimethylaminomethyl)-phenol, as component (D) for the formation of the further polymer on the basis of an epoxide resin.

18. The multi-component, on-site foaming system of claim 15, wherein the polyol component (B) contains a conventional cross-linking agent for the siloxane pre-polymer, preferably an organooxysilane with at least three methoxy end groups per molecule as component (D) for the formation of the further polymer based on a siloxane pre-polymer.

19. The multi-component, on-site foaming system of claim 15, wherein the polyol component (B) contains a polysiloxane as foam cell stabilizer.

20. The multi-component, on-site foaming system of claim 1, wherein the components (A), (B), (C) and/or (D) contain conventional fillers, auxiliary materials and/or additives in conventional amounts.

21. The multi-component, on-site, foaming system of claim 20, wherein it contains 0 to 40 percent by weight and preferably 1 to 20 percent by weight of a filler, selected from sand, chalk, perlite, carbon black or mixtures thereof, 0 to 2 percent by weight and preferably 0.1 to 1 percent by weight of one or more dyes and/or 0 to 40 percent by weight and preferably 1 to 20 percent by weight of a flame-retardant additive, in each case based on the weight of the on-site foaming system.

22. The multi-component, on-site foaming system of claim 1, wherein the containers, which contain the components (A) to (D), are connected by feed lines with a delivery device with a mixing head, in which the components are mixed.

23. The multi-component, on-site foaming system of claim 22, wherein the delivery device has a mixing head in the form of a mouthpiece with a static mixer.

24. The multi-component, on-site foaming system of claim 22, wherein the containers are provided with extrusion devices, over which the components (A) to the (D) can be bought into the mixing head of the delivery device.

25. The multi-component, on-site foaming system of claim 24, wherein mechanical pressing devices and/or propellants, which are contained in components (A) to (D) and/or in the pressure chamber of a two-chamber cartridge, are present as extrusion devices.

26. A method for sealing at least one of an opening and a bushing in at least one of walls and ceilings of buildings, comprising the steps of providing a multi-component, on-site foaming system for producing polyurethane foams on site for building purposes, with a polyisocyanate component (A) and a polyol component (B), which are in separate containers, wherein, aside from the polyisocyanate component (A) and the polyol component (B), further components (C) and (D) are contained in a spatially separate form, with the components, upon being mixed, forming an interpenetrating polymeric network of foamed polyurethane and at least one further polymer; introducing the multi-component, on-site foaming system with the help of the delivery device with mixing head, in which the components are mixed, into the at least one of an opening and a bushing; and foaming and curing the system.
